(19) United States
(12) Patent Application Publication
(10) Pub. No.: US 2018/0156272 A1
(43) Pub. Date: Jun. 7, 2018

(54) MOTOR

(71) Applicant: FANUC CORPORATION, Yamanashi (JP)

(72) Inventor: Taku OOHARA, Yamanashi (JP)

(73) Assignee: FANUC CORPORATION, Yamanashi (JP)

(21) Appl. No.: 15/823,660

(22) Filed: Nov. 28, 2017

(30) Foreign Application Priority Data
Dec. 1, 2016 (JP) 2016-234237

(51) Int. Cl. F16C 33/10

(52) U.S. Cl. CPC F16C 33/1045

(57) ABSTRACT

A motor capable of replacing a lubricant more easily is provided. A motor includes: a rotor supported by an output shaft-side bearing and an anti-output shaft-side bearing; a front housing that supports the output shaft-side bearing; a rear housing that supports the anti-output shaft-side bearing; a stator having both ends attached to the front housing and the rear housing, the stator surrounding the rotor; and a pair of pipelines which has an opening formed in a surface of the rotor close to the rear housing and which is provided inside the rotor, the pipelines communicating with at least one of the output shaft-side bearing and the anti-output shaft-side bearing and capable of circulating a lubricating liquid.

This application is based on and claims the benefit of priority from Japanese Patent Application No. 2016-234237, filed on 1 Dec. 2016, the content of which is incorporated herein by reference.

### BACKGROUND OF THE INVENTION

### Field of the Invention

The present invention relates to a motor.

### Related Art

From the past, motors that support a rotor using bearings are widely known. In general, bearings are configured to use a lubricant from the view point of reducing friction and wearing and discharging frictional heat. By using a lubricant, it is possible to extend lifespan of the bearings. As a bearing having a lubricant enclosed therein, a water pump in which a hollow portion is formed in a rotation shaft of the water pump, a lubricating oil (the lubricant) is stored in the hollow portion, the lubricating oil (the lubricant) is press-fitted from the hollow portion into a bearing using a communication hole that passes through an outer circumference of the rotation shaft is proposed (for example, see Patent Document
Patent Document 1: Japanese Unexamined Patent Application, Publication No. H10-103289

### SUMMARY OF THE INVENTION

However, a lubricant deteriorates with use due to oxidation, contamination, and the like. Since continued use of the deteriorated lubricant leads to damage to the motor, it is preferable to replace the deteriorated lubricant. Since the water pump of Patent Document 1 does not have a mechanism for replacing the lubricant, it is not possible to replace the lubricant.

On the other hand, when bearings are built into a housing or the like during replacement of the lubricant, it is necessary to completely disassemble the motor so that a shaft portion is exposed. Due to this, there is a case in which it is difficult to replace the lubricant and a motor capable of replacing the lubricant more easily is desirable.

An object of the present invention is to provide a motor capable of replacing a lubricant more easily.

(1) A motor (for example, a motor 10 to be described later) of the present invention includes: a rotor (for example, a rotor 20 to be described later) supported by an output shaft-side bearing (for example, an output shaft-side bearing 11 to be described later) and an anti-output shaft-side bearing (for example, an anti-output shaft-side bearing 12 to be described later); a front housing (for example, a front housing 40 to be described later) that supports the output shaft-side bearing; a rear housing (for example, a rear housing 60 to be described later) that supports the anti-output shaft-side bearing; a stator (for example, a stator 30) having both ends attached to the front housing and the rear housing, the stator surrounding the rotor; and a pair of pipelines (for example, a pair of pipelines 16a and 16b to be described later) which has an opening (for example, an opening 17a, 17b to be described later) formed in a surface of the rotor close to the rear housing and which is provided inside the rotor, the pipelines communicating with at least one of the output shaft-side bearing and the anti-output shaft-side bearing and capable of circulating a lubricating liquid.

(2) In the motor according to (1), it is preferable that the opening is formed in an end surface of the rotor close to the rear housing.

(3) In the motor according to (1) or (2), it is preferable that the pair of pipelines are disposed at positions symmetric about an axis of the rotor.

According to the present invention, it is possible to provide a motor capable of replacing a lubricant more easily.

### BRIEF DESCRIPTION OF THE DRAWINGS

FIG. 1 is a longitudinal cross-sectional view schematically illustrating a motor according to an embodiment of the present invention.

FIG. 2 is a partial enlarged view illustrating an output shaft-side portion of the motor illustrated in FIG. 1 at an enlarged scale.

FIG. 3 is a partial enlarged view illustrating an anti-output shaft-side portion of the motor illustrated in FIG. 1 at an enlarged scale.

FIG. 4 is a diagram seen from arrow A in FIG. 3.

### DETAILED DESCRIPTION OF THE INVENTION

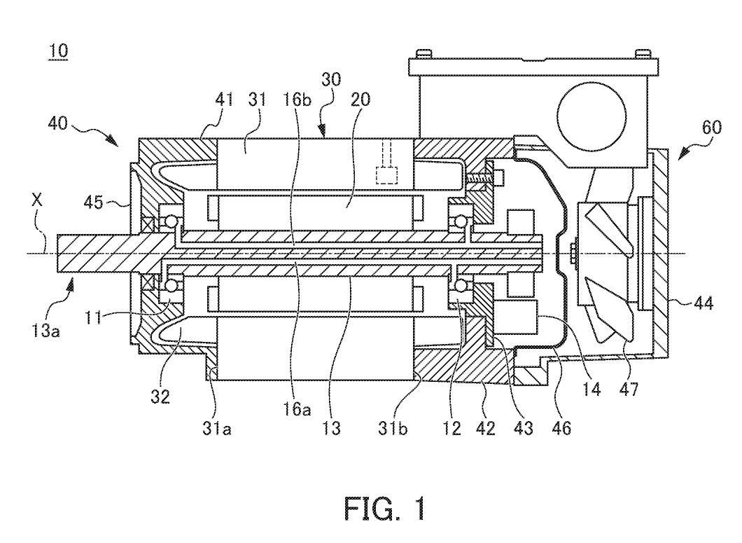

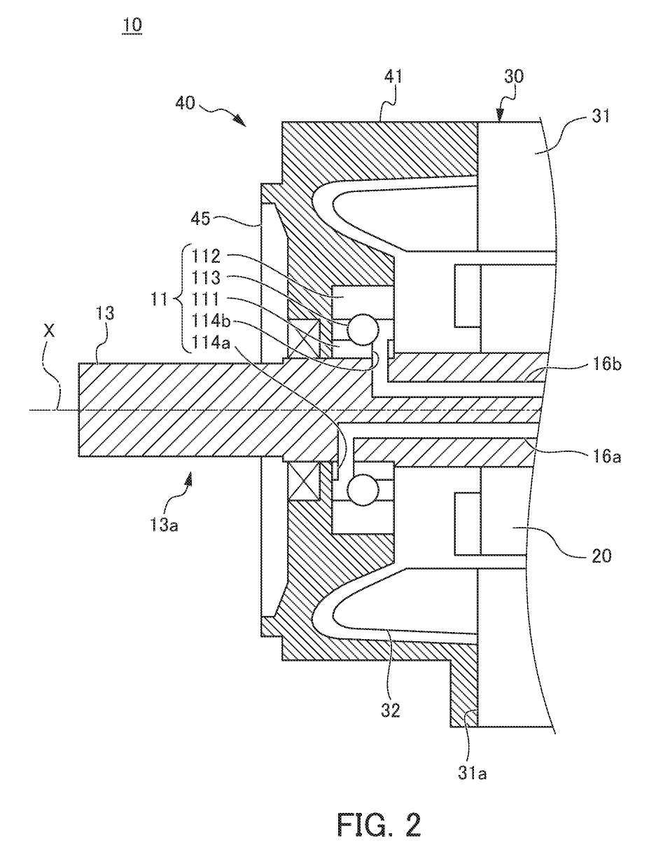

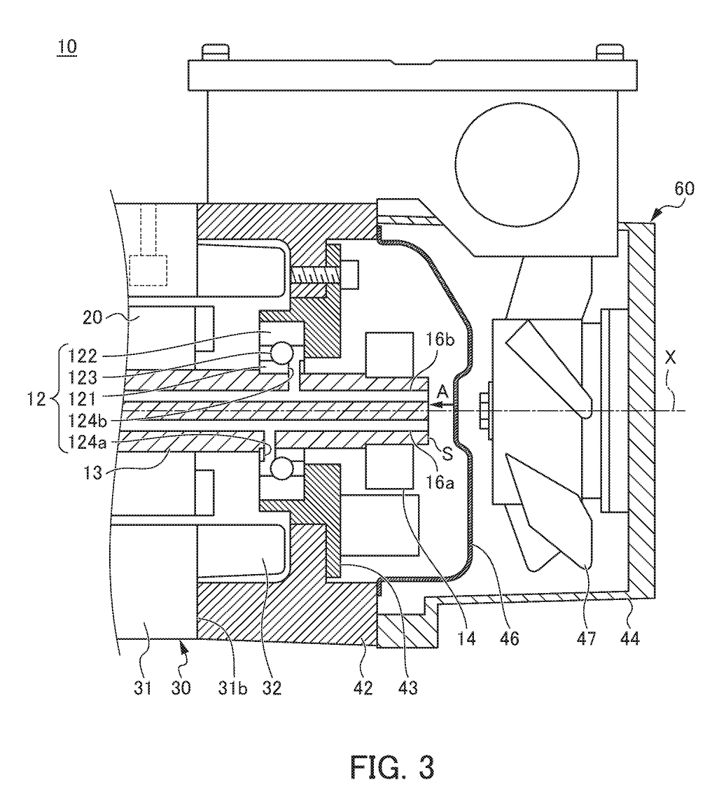

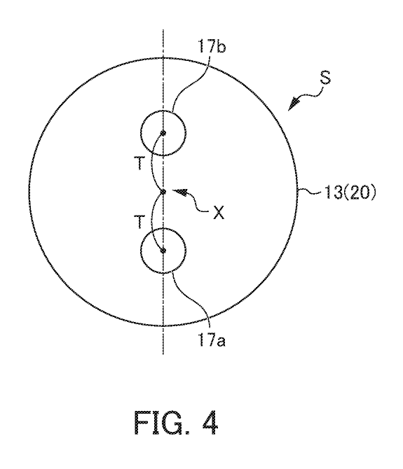

An embodiment of a motor according to the present invention will be described with reference to FIGS. 1 to 4. FIG. 1 is a longitudinal cross-sectional view schematically illustrating a motor according to an embodiment of the present invention. FIG. 2 is a partial enlarged view illustrating an output shaft-side portion of the motor illustrated in FIG. 1 at an enlarged scale. FIG. 3 is a partial enlarged view illustrating an anti-output shaft-side portion of the motor illustrated in FIG. 1 at an enlarged scale. FIG. 4 is a diagram seen from arrow A in FIG. 3.

A motor 10 of the present embodiment includes, as its main components, a rotor 20 (a rotating member), a stator 30 (a stationary member), a front housing 40, a rear housing 60, an output shaft-side bearing 11, an anti-output shaft-side bearing 12, and a pair of pipelines 16a and 16b.

The rotor 20 is supported by an output shaft-side bearing 11 and an anti-output shaft-side bearing 12. Specifically, the rotor 20 includes a rotation shaft 13. Both ends of the rotation shaft 13 are supported by the output shaft-side bearing 11 and the anti-output shaft-side bearing 12. Moreover, the rotation shaft 13 is supported so as to be able to rotate around the axis of rotation X. The rotor 20 rotates integrally with the rotation shaft 13 around the axis of rotation X.

The rotation shaft 13 has a front end 13a and a rear end 13b. The front end 13a is positioned at an end of the rotation shaft 13 close to a side (hereinafter also referred to as an “output shaft-side”) of the output shaft-side bearing 11. The rear end 13b is positioned at an end of the rotation shaft 13 close to a side (hereinafter also referred to as an “anti-output shaft-side”) of the anti-output shaft-side bearing 12. An encoder 14 is attached to the rear end 13b. The encoder 14 detects a rotation position, a rotation speed, and the like of the rotation shaft 13.

The stator 30 is a member that surrounds the rotor 20. Specifically, the stator 30 is an approximately cylindrical member extending along the axis of rotation X so as to surround the rotor 20. The stator 30 includes a stator core 31 and a winding 32. The stator core 31 is made up of a number of stacked electromagnetic steel plates. The winding 32 is wound around a projecting portion (not illustrated) formed on an inner circumferential surface of the stator core 31.

The stator core 31 has a front end surface 31a and a rear end surface 31b. The front end surface 31a is positioned at the end close to the output shaft-side bearing 11. The rear end surface 31b is positioned at the end close to the anti-output shaft-side bearing 12.

The winding 32 is fixed to the stator core 31 by a resin or the like. The winding 32 extends along the axis of rotation X so as to protrude from both ends of the stator core 31. A lead wire (not illustrated) extended from a terminal box 15 (to be described later) is connected to the winding 32. The winding 32 generates a rotating magnetic field according to current supplied via the lead wire. The rotor 20 rotates integrally with the rotation shaft 13 according to the rotating magnetic field generated by the stator 30.

The front housing 40 supports the output shaft-side bearing 11. The rear housing 60 supports the anti-output shaft-side bearing 12. The front housing 40 has a front housing component 41 and a front cover 45. Moreover, the rear housing 60 has a rear housing component 42, a supporting ring 43, a rear cover 44, an intermediate cover 46, and a fan 47.

The front housing component 41 and the rear housing component 42 surround the winding 32 protruding from the stator core 31.

The front housing component 41 is fixed to the front end surface 31a of the stator core 31 by screws. The front housing component 41 supports the output shaft-side bearing 11. The front housing component 41 extends from the front end surface 31a of the stator core 31 toward the front end 13a of the rotation shaft 13. The front housing component 41 surrounds the output shaft-side bearing 11 and a portion of the rotation shaft 13. Moreover, the front cover 45 having an approximately ring shape is provided in the front housing component 41.

The front cover 45 protrudes radially inward toward the rotation shaft 13. The front end 13a of the rotation shaft 13 protrudes from the front cover 45 and the front housing component 41. The front end 13a of the rotation shaft 13 protruding from the front cover 45 and the front housing component 41 functions as an output shaft which is directly or indirectly connected to a main shaft of a machine tool, for example.

The rear housing component 42 is fixed to the rear end surface 31b of the stator core 31 by screws. The rear housing component 42 extends from the rear end surface 31b of the stator core 31 toward the rear end 13b of the rotation shaft 13. The rear housing component 42 surrounds the anti-output shaft-side bearing 12 and a portion of the rotation shaft 13.

The supporting ring 43 is fixed to the rear housing component 42 by screws. The supporting ring 43 supports the anti-output shaft-side bearing 12. The rear cover 44 is provided in the rear housing component 42. The rear cover 44 surrounds the rear end 13b of the rotation shaft 13 protruding from the rear housing component 42. The terminal box 15 is a member having an inner space. The terminal box 15 is connected to the rear housing component 42.

The intermediate cover 46 is fixed to the supporting ring 43 by screws. The intermediate cover 46 is disposed between the supporting ring 43 and the rear cover 44. The fan 47 is fixed to an inner surface of the rear cover 44. The fan 47 is disposed with its axial center aligned with respect to the rotation shaft 13.

The output shaft-side bearing 11 is disposed near the front end 13a of the rotation shaft 13. The output shaft-side bearing 11 supports the front end 13a of the rotation shaft 13. The output shaft-side bearing 11 contains a high viscosity lubricant therein. As illustrated in FIG. 2, the output shaft-side bearing 11 includes an output shaft-side inner ring 111, an output shaft-side outer ring 112, an output shaft-side rolling element 113, and a pair of through-holes 114a and 114b.

The output shaft-side inner ring 111 is formed in a ring form having such a diameter that the output shaft-side inner ring 111 can engage with the front end 13a of the rotation shaft 13. An inner circumferential surface of the output shaft-side inner ring 111 engages with an outer circumferential surface of the front end 13a. A groove extending in a circumferential direction is formed in the outer circumferential surface of the output shaft-side inner ring 111.

The output shaft-side outer ring 112 is formed in a ring form. The output shaft-side outer ring 112 has a larger inner diameter than the diameter of the output shaft-side inner ring 111. The output shaft-side outer ring 112 is disposed so that the inner circumferential surface faces the outer circumferential surface of the output shaft-side inner ring 111. That is, the output shaft-side outer ring 112 is disposed so that the output shaft-side outer ring 112 and the output shaft-side inner ring 111 form a double ring shape. A groove extending in a circumferential direction is formed in the inner circumferential surface of the output shaft-side outer ring 112. Moreover, a lubricant is contained between the output shaft-side outer ring 112 and the output shaft-side inner ring 111.

The output shaft-side rolling element 113 is a sphere and is supported by the grooves formed in the output shaft-side inner ring 111 and the output shaft-side outer ring 112 so as to be able to rotate and revolve. A plurality of output shaft-side rolling elements 113 is formed along the groove. The output shaft-side rolling element 113 rotates and revolves to enable rotation of the output shaft-side inner ring 111 in relation to the output shaft-side outer ring 112.

The pair of through-holes 114a and 114b pass from the inner circumferential surface of the output shaft-side inner ring 111 to the outer circumferential surface. The pair of through-holes 114a and 114b are disposed at positions symmetric about the axis (the axis of rotation X) of the rotation shaft 13. Moreover, one through-hole 114a is disposed closer to the front end 13a than an axial central position of the output shaft-side inner ring 111. The other through-hole 114b is disposed closer to the rear end 13b than the axial central position of the output shaft-side inner ring 111.

The anti-output shaft-side bearing 12 is disposed close to the rear end 13b of the rotation shaft 13. The anti-output shaft-side bearing 12 supports the rear end 13b of the rotation shaft 13. The anti-output shaft-side bearing 12 contains a high viscosity lubricant therein. As illustrated in FIG. 3, the output shaft-side bearing 11 includes an anti-output shaft-side inner ring 121, an anti-output shaft-side outer ring 122, an anti-output shaft-side rolling element 123, and a pair of through-holes 124a and 124b.

The anti-output shaft-side inner ring 121 is formed in a ring form having such a diameter that the anti-output shaft-side inner ring 121 can engage with the rear end 13b of the rotation shaft 13. The inner circumferential surface of the anti-output shaft-side inner ring 121 engages with the outer circumferential surface of the rear end 13b. A groove extending along the circumferential direction is formed in the outer circumferential surface of the anti-output shaft-side inner ring 121.

The anti-output shaft-side outer ring 122 is formed in a ring form. The anti-output shaft-side outer ring 122 has a larger inner diameter than the diameter of the anti-output shaft-side inner ring 121. The anti-output shaft-side outer ring 122 is disposed so that the inner circumferential surface faces the outer circumferential surface of the anti-output shaft-side inner ring 121. That is, the anti-output shaft-side outer ring 122 is disposed so that the anti-output shaft-side outer ring 122 and the anti-output shaft-side inner ring 121 form a double ring shape. A groove extending along the circumferential direction is formed in the inner circumferential surface of the anti-output shaft-side outer ring 122. Moreover, a lubricant is contained between the anti-output shaft-side outer ring 122 and the anti-output shaft-side inner ring 121.

The anti-output shaft-side rolling element 123 is a sphere. The anti-output shaft-side rolling element 123 is supported by the grooves formed in the anti-output shaft-side inner ring 121 and the anti-output shaft-side outer ring 122 so as to be able to rotate and revolve. A plurality of anti-output shaft-side rolling elements 123 is formed along the groove. The anti-output shaft-side rolling element 123 rotates and revolves to enable rotation of the anti-output shaft-side inner ring 121 in relation to the anti-output shaft-side outer ring 122.

The pair of through-holes 124a and 124b pass from the inner circumferential surface of the anti-output shaft-side inner ring 121 to the outer circumferential surface. The pair of through-holes 124a and 124b are disposed at positions symmetric about the axis (the axis of rotation X) of the rotation shaft 13. Moreover, one through-hole 124a is disposed closer to the front end 13a than an axial central position of the anti-output shaft-side inner ring 121. The other through-hole 124b is disposed closer to the rear end 13b than the axial central position of the anti-output shaft-side inner ring 121.

The pair of pipelines 16a and 16b are formed inside the rotor 20. The pair of pipelines 16a and 16b have openings 17a and 17b formed in a surface of the rotor 20 close to the rear housing 60. Specifically, the pair of pipelines 16a and 16b are formed inside the rotation shaft 13. The pair of pipelines 16a and 16b have openings 17a and 17b formed in a surface of the rotation shaft 13 close to the rear housing 60. The pair of pipelines 16a and 16b communicate with at least one of the output shaft-side bearing 11 and the anti-output shaft-side bearing 12. The pair of pipelines 16a and 16b are configured so as to be able to circulate a lubricating liquid. The pair of pipelines 16a and 16b are disposed at positions symmetric about the axis of the rotor 20. In the present embodiment, the pair of pipelines 16a and 16b are bifurcated inside the rotation shaft 13. The pair of pipelines 16a and 16b communicate with both the output shaft-side bearing 11 and the anti-output shaft-side bearing 12.

As illustrated in FIG. 4, the openings 17a and 17b of the pair of pipelines 16a and 16b are formed in an end surface S of the rotor 20 (the rotation shaft 13) close to the rear housing 60. The openings 17a and 17b of the pair of pipelines 16a and 16b are disposed at positions symmetric about the axis (the axis of rotation X) of the rotation shaft 13. Specifically, the openings 17a and 17b of the pair of pipelines 16a and 16b are symmetric about the axis (the axis of rotation X) of the rotation shaft 13. Moreover, the pair of pipelines 16a and 16b are disposed to be separated by a distance T from the axis (the axis of rotation X). Moreover, the openings 17a and 17b of the pair of pipelines 16a and 16b are closed by lids (not illustrated) in a normal time (when the lubricant is not replaced).

One pipeline 16a extends linearly along the axial center of the rotation shaft 13 from the opening 17a formed in the end surface S of the rotation shaft 13 close to the rear housing 60. One pipeline 16a is bifurcated to communicate with one of the pair of through-holes 114a and 114b of the output shaft-side bearing 11 and one of the pair of through-holes 124a and 124b of the anti-output shaft-side bearing 12. In the present embodiment, one pipeline 16a communicates with the through-holes 114a and 124a positioned closer to the front end 13a. Due to this, one pipeline 16a functions as a supply path of a lubricant, for example.

The other pipeline 16b extends linearly along the axial center of the rotation shaft 13 from the opening 17b formed in the end surface S of the rotation shaft 13 close to the rear housing 60. The other pipeline 16b is bifurcated to communicate with the other of the pair of through-holes 114a and 114b of the output shaft-side bearing 11 and the other of the pair of through-holes 124a and 124b of the anti-output shaft-side bearing 12. In the present embodiment, the other pipeline 16b communicates with the through-holes 114b and 124b positioned closer to the rear end 13b. Due to this, the pipeline 16 functions as a discharge path of a lubricant, for example.

The lubricant of the motor 10 having such the above-described configuration is replaced in the following manner. First, rotation of the rotor 20 (the rotation shaft 13) is stopped. Subsequently, the rear cover 44 and the intermediate cover 46 are removed. In this way, a side of the rotor 20 (the rotation shaft 13) close to the rear housing 60 is exposed to the outside. That is, the end surface S of the rotor 20 (the rotation shaft 13) close to the rear housing 60 is exposed to the outside. Therefore, the openings 17a and 17b of the pair of pipelines 16a and 16b are exposed to the outside.

Subsequently, the lids (not illustrated) are removed from the openings 17a and 17b of the pair of pipelines 16a and 16b. Moreover, a lubricant is supplied from the opening 17a of one pipeline 16a. In this way, the lubricant is injected into the output shaft-side bearing 11 and the anti-output shaft-side bearing 12 via one set of through-holes 114a and 124a. When the lubricant is injected, an amount of the lubricant (deteriorated lubricant) approximately the same as the injected lubricant, having already been contained in the output shaft-side bearing 11 and the anti-output shaft-side bearing 12 is discharged through the other through-holes 114b and 124b. The discharged lubricant circulates through the other pipeline 16b and is discharged from the opening 17b.

Here, the pair of through-holes 114a and 114b and the pair of through-holes 124a and 124b are symmetric about the axis (the axis of rotation X) of the rotor 20 (the rotation shaft 13). Moreover, one set of through-holes 114a and 124a (the supply side) are positioned closer to the front end 13a, and the other set of through-holes 124a and 124b (the discharge side) are positioned closer to the rear end 13b. That is, the pair of through-holes 114a and 114b are disposed so that a path extending from one through-hole 114a to the other through-hole 114b is the longest. Moreover, the pair of through-holes 124a and 124b are disposed so that a path extending from one through-hole 124a to the other through-hole 124b is the longest. In this way, the lubricant which is already contained in the output shaft-side bearing 11 and the anti-output shaft-side bearing 12 is discharged preferentially.

Moreover, a sufficient amount of the lubricant is supplied, whereby the entire lubricant contained in the output shaft-side bearing 11 and the anti-output shaft-side bearing 12 is replaced with a new lubricant. After replacement of the lubricant ends, the openings 17a and 17b of the pair of pipelines 16a and 16b are closed by the lids (not illustrated) again. Moreover, the intermediate cover 46 and the rear cover 44 are attached again. In this way, the end surface S of the rotor 20 (the rotation shaft 13) close to the rear housing 60 is not exposed to the outside.

According to the motor 10 of the present embodiment, the following advantages are obtained, for example. The motor of the present embodiment includes: the rotor 20 supported by the output shaft-side bearing 11 and the anti-output shaft-side bearing 12; the front housing 40 that supports the output shaft-side bearing 11; the rear housing 60 that supports the anti-output shaft-side bearing 12; the stator 30 having both ends attached to the front housing 40 and the rear housing 60, the stator surrounding the rotor 20; and the pair of pipelines 16a and 16b which has the openings 17a and 17b formed in the surface of the rotor 20 close to the rear housing 60 and which is provided inside the rotor 20, the pipelines 16a and 16b communicating with at least one of the output shaft-side bearing 11 and the anti-output shaft-side bearing 12. Therefore, even when the output shaft-side bearing 11 and the anti-output shaft-side bearing 12 are surrounded by the front housing 40 and the rear housing 60, it is possible to expose the openings 17a and 17b to the outside without completely disassembling the motor. By supplying a lubricant from one opening 17a, since a deteriorated lubricant can be discharged from the other opening 17b via the pair of pipelines 16a and 16b, it is possible to replace the lubricant easily.

Moreover, the openings 17a and 17b are formed in the end surface of the rotor 20 close to the rear housing 60. Therefore, it is possible to further reduce a portion which is removed to expose the rotor 20 and to replace the lubricant more easily.

Moreover, the pair of pipelines 16a and 16b are disposed at positions symmetric about the axis (the axis of rotation X) of the rotor 20. Therefore, in at least one of the output shaft-side bearing 11 and the anti-output shaft-side bearing 12, a lubricant supply position and a lubricant discharge position are disposed at positions symmetric about the axis (the axis of rotation X) of the rotor 20. That is, the lubricant supply position and the lubricant discharge position are disposed at the farthest positions. Due to this, when supply of a new lubricant starts from the supply position, discharge of the used lubricant starts from the position farthest from the supply position. The used lubricant can be discharged preferentially until the entire used lubricant is replaced with a new lubricant. In this manner, it is possible to improve lubricant replacement efficiency.

The present invention is not limited to the above-described embodiment but can be changed and modified in various ways. For example, in the embodiment, the openings 17a and 17b of the pair of pipelines 16a and 16b are formed in the end surface of the rotor 20 (the rotation shaft 13) close to the rear housing 60. However, the present invention is not limited to the embodiment. The openings 17a and 17b of the pair of pipelines 16a and 16b may be formed in a circumferential surface closer to the rear housing 60 than the circumferential surface supported by the anti-output shaft-side bearing 12.

In the embodiment, each of the pair of pipelines 16a and 16b is bifurcated to communicate with both the output shaft-side bearing 11 and the anti-output shaft-side bearing 12. However, the present invention is not limited to the embodiment. For example, each of the pair of pipelines 16a and 16b may be configured to communicate with any one of the output shaft-side bearing 11 and the anti-output shaft-side bearing 12. Moreover, another pair of pipelines (not illustrated) may be provided inside the rotor 20. The other pair of pipelines (not illustrated) as well as the pair of pipelines 16a and 16b may communicate with one pair of through-holes 114a and 114b of the output shaft-side bearing 11 and one pair of through-holes 124a and 124b of the anti-output shaft-side bearing 12. In this case, the openings of the respective pipelines are preferably aligned in a radial direction of the end surface S. An opening of the pipeline as a supply pipe of the output shaft-side bearing 11 and an opening of the pipeline as a discharge side are preferably symmetric about an axis (the axis of rotation X) in the end surface S and are at equal distances from the axis (the axis of rotation X). The opening of the pipeline as a supply pipe of the anti-output shaft-side bearing 12 and the opening of the pipeline as a discharge side are preferably symmetric about the axis (the axis of rotation X) in the end surface S and are at equal distances from the axis (the axis of rotation X).

In the embodiment, the through-hole 114a positioned closer to the front end 13a among the pair of through-holes 114a and 114b is a supply side and the through-hole 114b positioned closer to the rear end 13b is a discharge side. In contrast, the through-hole 114a may be the discharge side. In this case, the through-hole 114b may be the supply side. Moreover, for example, in the output shaft-side bearing 11, the through-hole 114a positioned closer to the front end 13a may be the supply side. In this case, in the anti-output shaft-side bearing 12, the through-hole 124b positioned closer to the rear end 13b may be the supply side. That is, the relation between the supply side and the discharge side of the through-holes 114a and 114b and the relation between the supply side and the discharge side of the through-holes 124a and 124b may be changed alternately. The pair of pipelines 16a and 16b may be configured in various combinations as long as one pipeline is the supply side, the other pipeline is the discharge side, and the above-described advantages are obtained.

### EXPLANATION OF REFERENCE NUMERALS

10: Motor
11: Output shaft-side bearing
12: Anti-output shaft-side bearing
16: Pipeline
17: Opening
20: Rotor
30: Stator
40: Front housing
60: Rear housing
S: End surface

What is claimed is:

1. A motor comprising:
a rotor supported by an output shaft-side bearing and an anti-output shaft-side bearing;
a front housing that supports the output shaft-side bearing;
a rear housing that supports the anti-output shaft-side bearing;
a stator having both ends attached to the front housing and the rear housing, the stator surrounding the rotor; and
a pair of pipelines which has an opening formed in a surface of the rotor close to the rear housing and which is provided inside the rotor, the pipelines communicating with at least one of the output shaft-side bearing and the anti-output shaft-side bearing and capable of circulating a lubricating liquid.

2. The motor according to claim 1, wherein
the opening is formed in an end surface of the rotor close to the rear housing.

3. The motor according to claim 1, wherein
the pair of pipelines are disposed at positions symmetric about an axis of the rotor.
